(19) United States
(12) Patent Application Publication
(10) Pub. No.: US 2010/0096529 A1
(43) Pub. Date: Apr. 22, 2010

(54) Stand for supporting a window sash while in a window frame when the window sash is tilted-in relative to the window frame and method

(76) Inventor: Peter M. Kritsky, Glen Wild, NY (US)

Correspondence Address: CHARLES E. BAXLEY, ESQUIRE, 90 JOHN STREET, SUITE 309, NEW YORK, NY, 10038, US

(21) Appl. No.: 12/288,543

(22) Filed: Oct. 21, 2008

(51) Int. Cl. F16M 11/28; F16M 13/00

(52) U.S. Cl. 248/407; 248/158; 248/161

(57) ABSTRACT

A stand for supporting a window sash while in a window frame when the window sash is tilted-in relative to the window frame and method. The stand includes a base, an upright, and a supporter. The base rests on a horizontal surface, adjacent to the window frame. The upright extends vertically upwardly from the base to an upper end thereof. The supporter extends transversely across the upper end of the upright and supports the window sash while in the window frame when the window sash is tilted-in relative to the window frame.

### 1. BACKGROUND OF THE INVENTION

A. Field of the Invention

The embodiments of the present invention relate to a stand, and more particularly, the embodiments of the present invention relate to a stand for supporting a window sash while in a window frame when the window sash is tilted-in relative to the window frame and method.

B. Description of the Prior Art

When painting, washing, or working on a window by an operator, the window at times must be pivoted inwardly about a horizontal axis toward the operator. When this occurs:
the window sash is not properly balanced in tracks of the window sash;
a level surface is not provided; and
a finish of a sill of the window frame is not protected from marring by the window sash or vise versa.

Thus, there exists a need for an innovation that will:
properly balance a window sash of a window in tracks of the window sash while the window sash is being tilted-in relative to a window frame;
provide a level surface while cleaning or otherwise performing work on the window or the window frame; and
protect a finish of a sill of the window frame from marring by the window sash or vise versa when the window sash is tilted-in relative to the window frame.

Numerous innovations for stands and window-related devices have been provided in the prior art, which will be described below in chronological order to show advancement in the art, and which are incorporated herein by reference thereto. Even though these innovations may be suitable for the specific individual purposes to which they address, however, they differ from the present invention in that they do not teach a stand for supporting a window sash while in a window frame when the window sash is tilted-in relative to the window frame and method.

(1) U.S. Pat. No. 856,679 to Buckland.

U.S. Pat. No. 856,679 issued to Buckland on Jun. 11, 1907 teaches a stand including a tubular pillar, a block having slots and slidable within the pillar, legs pivoted to the block, stay rods connecting the legs together and jointed at their middle part, a tube telescoping into the pillar, a thumb screw securing the tube within the pillar, a quadrant bracket having a stem fitting into the top of the tube, a thumb screw securing the stem to the tube, and a tubular arm pivoted to the quadrant bracket. The upper part of the arm telescopes into the lower part. A pin-fitting hole is provided in the quadrant and a hole in the arm, a mirror, a bracket upon the back of the mirror, and a pin by which the mirror is pivoted to the oscillating arm.

(2) U.S. Pat. No. 2,702,205 to Germain.

U.S. Pat. No. 2,702,205 issued to Germain on Feb. 15, 1955 in U.S. class 292 and subclass 275 teaches a swinging window of the type including a window frame, a sash hingedly connected to an upper portion of the window frame, a window screen closing the window frame, and a window operator. The window operator includes a mounting bracket secured to a lower portion of the sash. A first rod section is terminally pivotally connected to the mounting bracket. An enlarged bore through the window screen is aligned with the mounting bracket when the sash is in a closed position. A latch is carried by the window frame. The latch includes a mounting flange secured to the window frame and extends beneath the window screen. A vertical guide flange is carried by the mounting flange, intermediate the ends thereof. The guide flange abuts an inner surface of the window screen and partially closes the bore. A rod-section receiving-opening in the guide flange directly communicates with the bore. A second rod section is terminally pivotally connected to the first end section, remote from the mounting bracket, and normally forms an extension of the first rod section. The second rod section passes through the bore and the opening when the sash is in an open position. An upstanding lip is on the mounting flange, in closely adjacent spaced relation to the guide flange. A gravity-actuated latch element has a lower end thereof seated in the space between the lip and the guide flange. An aperture in the latch element normally receives the second rod section. The latch element and the guide flange cooperate to selectively retain either the first rod section or the second rod section in adjusted positions to retain and lock the window in selected positions. Catch apparatus carried by the inner surface of the window screen, remote from the guide flange, receives and supports the second rod section when in an operative position.

(3) U.S. Pat. No. 3,677,592 to Navara.

U.S. Pat. No. 3,677,592 issued to Navara on Jul. 18, 1972 in U.S. class 292 and subclass 288 teaches an adjustable window brace for positioning balanced and storm windows at a selected position.

(4) United States Patent Application Publication Number US 2003/0090904 A1 to Ching.

United States Patent Application Publication Number US 2003/0090904 A1 published to Ching on May 15, 2003 in U.S. class 362 and subclass 413 teaches a work-light stand with a light installed thereon, which includes an adjustable lever. The length of the adjustable lever is fixable by a fastening device. Supporting legs are hinged to the adjustable lever and maintain the work-light stand in the upright standing position. The fastening device is of a notched ring structure where a body core pierces across the notch, and a working lever is hinged to one end of the body core and can be tightened in the notch to tighten or loosen the fastener, which in turn fastens or releases between the first lever and the second lever.

(5) U.S. Pat. No. 6,663,073 B1 to Church.

U.S. Pat. No. 6,663,073 B1 issued to Church on Dec. 16, 2003 in U.S. class 248 and subclass 458 teaches a collapsible easel providing a display surface for two visual displays. The easel includes a fixed base and a rotatable base being rotatable with respect to the fixed base. On top of the rotatable base is a visual display support. On opposed sides of the rotatable base are located tray edge braces supporting a bottom of an outwardly leaning edge of the visual display. The visual display may be of different heights and/or widths and be of a different median, such as flip charts, dry erase boards, foam display boards, etc.

(6) U.S. Pat. No. 7,325,847 B1 to Tanner.

U.S. Pat. No. 7,325,847 B1 issued to Tanner on Feb. 5, 2008 in U.S. class 292 and subclass 339 teaches a device for maintaining an openable window in a desired position within a window frame. The device includes a rod having a top end and a bottom end and a housing having a top end, a bottom end, a front surface, and a rear surface. A first aperture is formed in the housing. A second aperture is formed in the bottom end of the housing, with the rod slidably receivable into the first aperture, through the housing, and out of the second aperture. A grasping mechanism is secured on the housing for releasably grasping the openable window. An adjusting mechanism selectively adjusts the position of the housing on the rod.

It is apparent that numerous innovations for stands and window-related devices have been provided in the prior art that are adapted to be used. Furthermore, even though these innovations may be suitable for the specific individual purposes to which they address, however, they would not be suitable for the purposes of the embodiments of the present invention as heretofore described, namely, a stand for supporting a window sash while in a window frame when the window sash is tilted-in relative to the window frame and method.

### 2. SUMMARY OF THE INVENTION

Thus, an object of the embodiments of the present invention is to provide a stand for supporting a window sash while in a window frame when the window sash is tilted-in relative to the window frame and method, which avoids the disadvantages of the prior art.

Briefly stated, another object of the embodiments of the present invention is to provide a stand for supporting a window sash while in a window frame when the window sash is tilted-in relative to the window frame and method. The stand includes a base, an upright, and a supporter. The base rests on a horizontal surface, adjacent to the window frame. The upright extends vertically upwardly from the base to an upper end thereof. The supporter extends transversely across the upper end of the upright and supports the window sash while in the window frame when the window sash is tilted-in relative to the window frame.

The novel features considered characteristic of the embodiments of the present invention are set forth in the appended claims. The embodiments of the present invention themselves, however, both as to their construction and their method of operation together with additional objects and advantages thereof will be best understood from the following description of the specific embodiments when read and understood in connection with the accompanying drawing.

### 3. BRIEF DESCRIPTION OF THE DRAWING

The figures of the drawing are briefly described as follows:

FIG. 1 is a diagrammatic perspective view of the stand of the embodiments of the present invention supporting a window sash while in a window frame when the window sash is tilted-in relative to the window frame;

FIG. 2 is an enlarged diagrammatic perspective view of the stand of the embodiments of the present invention identified by ARROW 2 in FIG. 1; and

FIG. 3 is an enlarged diagrammatic perspective view of the area generally enclosed by the dotted circle identified by ARROW 3 in FIG. 2.

### 4. LIST OF REFERENCE NUMERALS UTILIZED IN THE DRAWING

A. General.
10 stand of embodiments of present invention for supporting window sash 12 while in window frame 14 when window sash 12 is tilted-in relative to window frame 14
12 window sash
14 window frame

B. Configuration of Stand 10.
20 base for resting on horizontal surface 26
22 upright
24 supporter for supporting window sash 12 while in window frame 14 when window sash 12 is tilted-in relative to window frame 14
26 horizontal surface
28 upper end of upright 22
30 outer tube of upright 22
32 inner tube of upright 22
34 spring-loaded push-button of inner tube 32 of upright 22
36 plurality of through bores in outer tube 30 of upright 22
38 front face of supporter 24
40 pair of stop tabs of supporter 24 for cradling window sash 12 thereagainst when window sash 12 is tilted-in relative to window frame 14
42 lower end of outer tube 30 of upright 22
44 cross-piece of base 20 for resting on horizontal surface 26
46 leg of base 20 for resting on horizontal surface 26

### 5. DETAILED DESCRIPTION OF THE PREFERRED EMBODIMENTS

A. General.

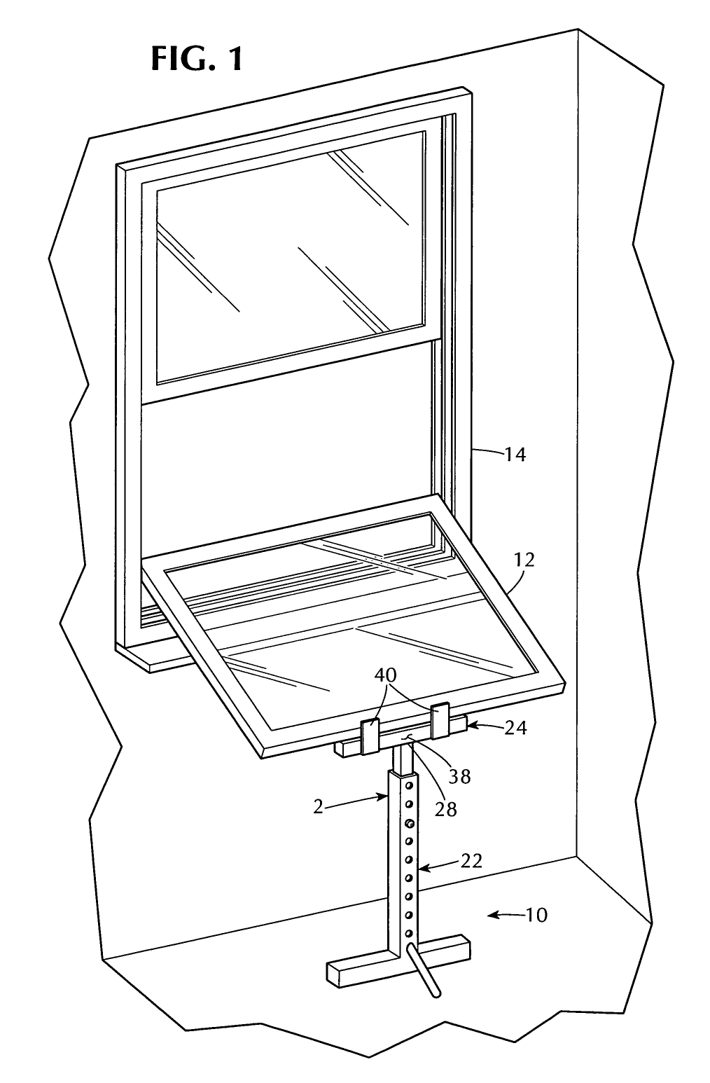

Referring now to the figures, in which like numerals indicate like parts, and particularly to FIG. 1, which is a diagrammatic perspective view of the stand of the embodiments of the present invention supporting a window sash while in a window frame when the window sash is tilted-in relative to the window frame, the stand of the embodiments of the present invention is shown generally at 10 for supporting a window sash 12 while in a window frame 14 when the window sash 12 is tilted-in relative to the window frame 14.

B. The Configuration of the Stand 10.

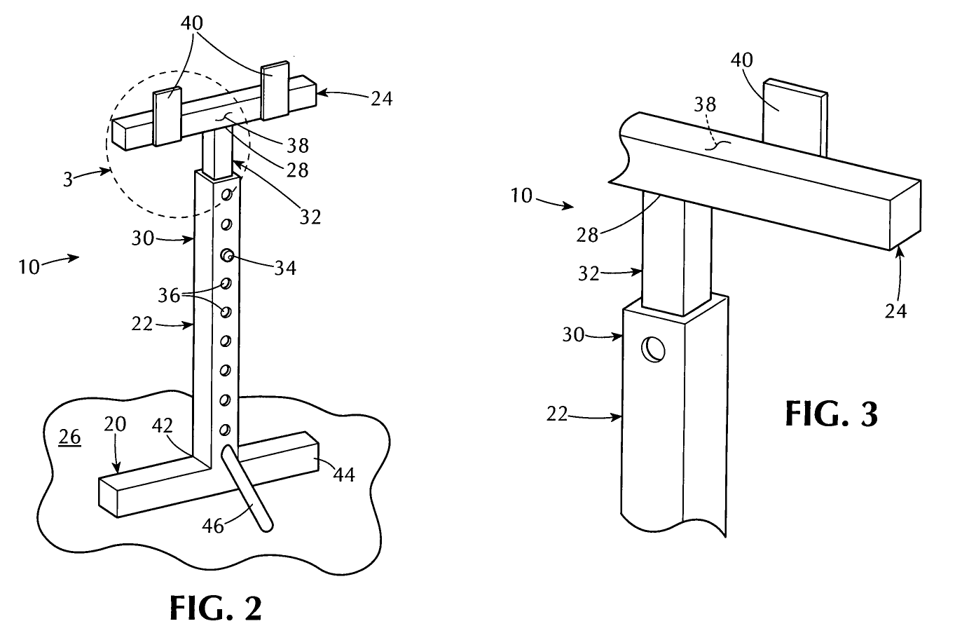

The configuration of the stand 10 can best be seen in FIGS. 2 and 3, which are, respectively, an enlarged diagrammatic perspective view of the stand of the embodiments of the present invention identified by ARROW 2 in FIG. 1, and an enlarged diagrammatic perspective view of the area generally enclosed by the dotted circle identified by ARROW 3 in FIG. 2, and as such, will be discussed with reference thereto.

The stand 10 comprises a base 20, an upright 22, and a supporter 24. The base 20 is for resting on a horizontal surface 26, adjacent to the window frame 14. The upright 22 extends vertically upwardly from the base 20 to an upper end 28 thereof. The supporter 24 extends transversely across the upper end 28 of the upright 22 and is for supporting the window sash 12 while in the window frame 14 when the window sash 12 is tilted-in relative to the window frame 14 (FIG. 1).

The upright 22 is height-adjustable by being telescopic, and as such, has an outer tube 30 and an inner tube 32. The inner tube 32 of the upright 22 is maintained at a selected height within the outer tube 30 of the upright 22 by the inner tube 32 of the upright 22 having a spring-loaded push-button 34 cooperating with a specific through bore of a plurality of through bores 36 in the outer tube 30 of the upright 22.

The inner tube 32 of the upright 22, together with the supporter 24, form a generally T-shaped configuration, with the upper end 28 of the upright 22 being disposed on the inner tube 32 of the upright 22.

The supporter 24 has a front face 38 and a pair of stop tabs 40. The pair of stop tabs 40 of the supporter 24 extend upwardly from the front face 38 of the supporter 24 and are for cradling the window sash 12 thereagainst when the window sash 12 is tilted-in relative to the window frame 14 (FIG. 1).

The outer tube 30 of the upright 22 has a lower end 42, and the base 20 has a cross-piece 44. The cross-piece 44 of the base 20 extends transversely across the lower end 42 of the outer tube 30 of the upright 22, and together with the outer tube 30 of the upright 22, form an inverted generally T-shaped configuration, and is for resting on the horizontal surface 26 to provide support for the stand 10.

The base 20 further has a leg 46. The leg 46 of the base 20 is retractably and diagonally attached to the lower end 42 of the outer tube 30 of the upright 22, intermediate the cross-piece 44 of the base 20, and is for resting on the horizontal surface 26 to provide further support for the stand 10.

C. The Advantages of the Stand 10 in Caste Order.
Properly balances a window sash in tracks of the window sash while the window sash is being tilted-in relative to a window frame;
Provides a level surface while cleaning or otherwise performing work on the window or the window frame; and
Protects a finish of a sill of the window frame from marring by the window sash or vise versa when the window sash is tilted-in relative to the window frame.

D. The Conclusions.

It will be understood that each of the elements described above or two or more together may also find a useful application in other types of constructions differing from the types described above.

While the embodiments of the present invention have been illustrated and described as embodied in a stand for supporting a window sash while in a window frame when the window sash is tilted-in relative to the window frame and method, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A stand for supporting a window sash while in a window frame when the window sash is tilted-in relative to the window frame, comprising:
a) a base;
b) an upright; and
c) a supporter;
wherein said base is for resting on a horizontal surface, adjacent to the window frame;
wherein said upright extends vertically upwardly from said base to an upper end thereof;
wherein said supporter extends transversely across said upper end of said upright; and
wherein said supporter is for supporting the window sash while in the window frame when the window sash is tilted-in relative to the window frame.

2. The stand of claim 1, wherein said upright is height-adjustable.

3. The stand of claim 1, wherein said upright is telescopic.

4. The stand of claim 1, wherein said upright has:
a) an outer tube; and
b) an inner tube.

5. The stand of claim 4, wherein said inner tube of said upright is maintained at a selected height within said outer tube of said upright by said inner tube of said upright having a spring-loaded push-button cooperating with a specific through bore of a plurality of through bores in said outer tube of said upright.

6. The stand of claim 4, wherein said inner tube of said upright, together with said supporter, form a generally T-shaped configuration.

7. The stand of claim 4, wherein said upper end of said upright is disposed on said inner tube of said upright.

8. The stand of claim 1, wherein said supporter has:
a) a front face; and
b) a pair of stop tabs;
wherein said pair of stop tabs of said supporter extend upwardly from said front face of said supporter; and
wherein said pair of stop tabs of said supporter are for cradling the window sash thereagainst when the window sash is tilted-in relative to the window frame.

9. The stand of claim 4, wherein said outer tube of said upright has a lower end;
wherein said base has a cross-piece;
wherein said cross-piece of said base extends transversely across said lower end of said outer tube of said upright;
wherein said cross-piece of said base, together with said outer tube of said upright, form an inverted generally T-shaped configuration; and
wherein said cross piece of said base is for resting on the horizontal surface to provide support for said stand.

10. The stand of claim 9, wherein said base has a leg;
wherein said leg of said base is retractably attached to said lower end of said outer tube of said upright;
wherein said leg of said base is diagonally attached to said lower end of said outer tube of said upright;
wherein said leg of said base is attached intermediate said cross-piece of said base; and
wherein said leg of said base is for resting on the horizontal surface to provide further support for said stand.

11. A method for properly balancing a window sash in tracks of the window sash while the window sash is being tilted-in relative to a window frame, for providing a level surface while cleaning or otherwise performing work on the window or the window frame, and for protecting a finish of a sill of the window frame from marring by the window sash or vise versa when the window sash is tilted-in relative to the window frame, the method comprising the step of supporting the window sash while in the window frame when the window sash is tilted-in relative to the window frame by a stand, which comprises:
a) a base;
b) an upright; and
c) a supporter;
wherein the base is for resting on a horizontal surface, adjacent to the window frame;
wherein the upright extends vertically upwardly from the base to an upper end thereof;
wherein the supporter extends transversely across the upper end of the upright; and
wherein the supporter is for supporting the window sash while in the window frame when the window sash is tilted-in relative to the window frame to thereby properly balance the window sash in the tracks of the window sash while the window sash is being tilted-in relative to a window frame, provide a level surface while cleaning or otherwise performing work on the window or the window frame, and protect a finish of a sill of the window frame from marring by the window sash or vise versa when the window sash is tilted-in relative to the window frame.

12. The method of claim 11, wherein the upright is height-adjustable.

13. The method of claim 11, wherein the upright is telescopic.

14. The method of claim 11, wherein the upright has:
a) an outer tube; and
b) an inner tube.

15. The method of claim 14, wherein the inner tube of the upright is maintained at a selected height within the outer tube of the upright by the inner tube of the upright having a spring-loaded push-button cooperating with a specific through bore of a plurality of through bores in the outer tube of the upright.

16. The method of claim 14, wherein the inner tube of the upright, together with the supporter, form a generally T-shaped configuration.

17. The method of claim 14, wherein the upper end of the upright is disposed on the inner tube of the upright.

18. The method of claim 11, wherein the supporter has:
a) a front face; and
b) a pair of stop tabs;
wherein the pair of stop tabs of the supporter extend upwardly from the front face of the supporter; and
wherein the pair of stop tabs of the supporter are for cradling the window sash thereagainst when the window sash is tilted-in relative to the window frame.

19. The method of claim 14, wherein the outer tube of the upright has a lower end;
wherein the base has a cross-piece;
wherein the cross-piece of the base extends transversely across the lower end of the outer tube of the upright;
wherein the cross-piece of the base, together with the outer tube of the upright, form an inverted generally T-shaped configuration; and
wherein the cross piece of the base is for resting on the horizontal surface to provide support for the stand.

20. The method of claim 19, wherein the base has a leg;
wherein the leg of the base is retractably attached to the lower end of the outer tube of the upright;
wherein the leg of the base is diagonally attached to the lower end of the outer tube of the upright;
wherein the leg of the base is attached intermediate the cross-piece of the base; and
wherein the leg of the base is for resting on the horizontal surface to provide further support for the stand.
